(19) United States
(12) Patent Application Publication
(10) Pub. No.: US 2011/0188668 A1
(43) Pub. Date: Aug. 4, 2011

(54) MEDIA DELIVERY SYSTEM

(76) Inventors: Mark Donaldson, Auckland (NZ); Luc Lussier, (US); Robert Patrick Beyer, (US); Robert David Beck, (US)

(21) Appl. No.: 12/888,561

(22) Filed: Sep. 23, 2010

Related U.S. Application Data
(60) Provisional application No. 61/244,996, filed on Sep. 23, 2009.

(51) Int. Cl. H04B 3/00

(52) U.S. Cl. 381/77

(57) ABSTRACT

A media delivery system which allows the user to control a media delivery device, such as an audio headset or earphone, from another device which may be remote from the media delivery device.

This utility patent application claims benefit of and incorporates herein by reference U.S. Provisional Patent Application Ser. No. 61/244,996, filed Sep. 23, 2009.

### TECHNICAL FIELD OF THE INVENTION

The present invention relates to entertainment apparatus and systems for controlling or enhancing delivery of media to individual users. In particular, the invention allows the user to control a media delivery device, such as an audio headset or earphone, from another device, such as a media player.

### BACKGROUND OF THE INVENTION

Portable media players have become increasingly popular. Users frequently use MP3 players, for example, to download large numbers of audio files in digital formats which are stored in a memory storage device such as flash memory or a small hard disk. Increasingly, media beyond audio are also being stored and played on such devices, for example, video clips or movies.

Along with the increasing popularity of these systems, there is a desire for users to be able to personalise their entertainment experience. The media delivery device can provide an enhanced user experience. For example, some headsets are provided with active noise cancellation (ANC). However, such additional features on the delivery device typically require controls to allow the user to fully customise or personalise the media delivery experience. Controls installed on a delivery device such as a headset are cumbersome, often aesthetically unpleasant and increase the probability of field faults.

### OBJECT OF THE INVENTION

It is an object of the present invention to provide an improved media delivery device or media delivery system.

Alternatively, it is an object of the present invention to provide an improved method for delivering media to a user.

In a further alternative it is an object of the invention to at least provide the public with a useful choice.

Further objects of the invention will become apparent from the following description.

### SUMMARY OF THE INVENTION

According to one aspect the invention provides media delivery apparatus comprising: a processor adapted to receive a media processing control signal corresponding to a media delivery characteristic selected by a user and process a media signal dependent on the media processing control signal to output a modified media signal; a transducer for receiving the modified media signal and providing the modified media signal for perception by a user.

The media delivery apparatus may comprise a headset. The processor may comprise a media player device.

In one embodiment the media processing control signal is obtained from a file stored on the media player device. In another embodiment the media processing control signal is obtained from a file streamed to the media player device.

The media processing control signal and the media signal are transmitted over the same communication channel.

The media processing control signal may operate to program or re-program the processor.

In one embodiment the media processing control signal is received from apparatus remote from the media delivery apparatus.

In another aspect the invention provides a method for delivering media to a user, the method including the steps of:

receiving an instruction from a user to provide media having a selected characteristic;

providing a media processing control signal corresponding to the selected characteristic to a processor;

using the media processing control signal to program the processor or modify one or more media processing parameters for operation of the processor;

using the processor to process a media signal in accordance with the modified media processing parameter(s) to modify the media signal, and;

providing the modified media signal to the user to thereby provide media having the selected characteristic.

According to another aspect of the present invention there is broadly provided a media delivery device comprising
receiving means for receiving a control signal;
a processing means for modifying a media signal based on the control signal; and output means for providing the modified media signal to a transducer for perception by a user.

In one embodiment the control signals and the media signal are received over an audio communications channel from the media player.

The media player may include a personal computer.

In another embodiment the control signals are received over a separate channel from the media signal.

Preferably the media signal comprises an audio signal, and in one embodiment the audio signal is received over an analogue communication channel.

In one embodiment the communication channel between the media player and the device is a wireless communication channel.

In another embodiment the communication channel comprises a wired communication channel.

In a further aspect of the invention there is broadly provided a media delivery system comprising a media delivery device according to the first aspect of the invention, and a media player.

In one embodiment the media player includes an interface which allows a user to configure the media delivery device, the interface providing for the generation of the control signals which are used by the processing means to modify the media signal to provide the required output to the user.

In another embodiment the media player is capable of receiving files which, when played on the media player, generate the control signals.

In another embodiment the media player is capable of navigating to a network location for receiving the control signals.

According to yet a further aspect of the invention there is broadly provided a method for media delivery, the method including the steps of providing a control signal to a media delivery device, the control signal being operative to modify processing parameters for processing a media signal provided to the media delivery device in accordance with a media delivery characteristic required by the user.

In a preferred embodiment the media characteristic may include one or more of:
active noise cancellation;
virtual surround sound;
bass enhancement;
enhancement of one or more preferred audio frequency components.

The invention also broadly consists in any new feature or combination of features referred to in this document, together with any equivalents of such features.

Further aspects of this invention which should be considered in all its novel aspects will become apparent from the following description given by way of example of a possible embodiment thereof.

### BRIEF DESCRIPTION OF THE DRAWINGS

One or more embodiments of the invention will be described below by way of example only and without intending to be at all limiting, with reference to the following drawings, in which:

FIG. 1: is a diagrammatic illustration of a media delivery device in accordance with the invention;

FIG. 2: diagrammatically illustrates a media delivery system including a media player and a media delivery device such as that described with reference to FIG. 1; and

FIG. 3: is a schematic outline of processing apparatus which may be included in the device shown in FIG. 1.

### DESCRIPTION OF PREFERRED EMBODIMENTS OF THE INVENTION

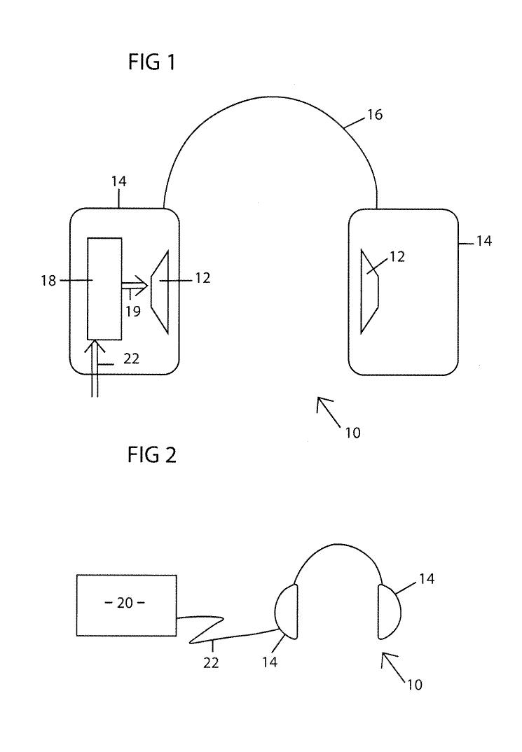

FIG. 1 illustrates a media delivery device generally referenced 10 according to an embodiment of the present invention. In this embodiment, the media delivery device comprises an audio headset. However, the media delivery device could deliver other forms of media, for example video media, i.e. the media delivery device could include a screen display for example.

The media delivery device 10 includes one or more transducers in the form of speakers 12 which are provided in ear cups 14 suspended from a head band 16. One or both cups 14, or the head band, include a processing device 18 such as a microprocessor as will be described further below.

Although existing media delivery devices may include circuitry which performs processing of the incoming media signals, the present invention allows for the processing circuitry to receive media processing control signals from remote apparatus which cause the incoming media signal received by the media delivery device to be processed in accordance with selected user requirements. For example a user may wish to implement active noise cancellation on headset 10. In order to do this, appropriate control signals are provided to the processor 18 which cause the processor to implement active noise cancellation. Similarly, the user may wish to implement audio effects such as three dimensional sound, or specific filtering of audio signals dependent upon the music that the listener is listening to, for example, jazz or classical music. The control signals are received over a wired or wireless connection referenced 22 in FIG. 1, and in one embodiment a media signal (such as an audio signal) is received over the same connection. The media signal as modified by the processor is provided to the speakers 12 as indicated by arrow 19.

As mentioned above, the invention may also be applied to media other than audio, but for the purposes of describing the invention by way of example herein, reference is made to delivery of audio media to a user.

A media delivery device such as the apparatus 10 of FIG. 1 provides a very significant advantage that it may be used with various media players, including a personal computer, through either a wired or wireless connection, to implement user preferences for media delivery which would otherwise not be possible using the media player.

Referring to FIG. 2, a diagrammatic illustration of a media player 20 is shown connected to a media delivery device 10 via a wired or wireless connection 22. The media player may be provided in or as a personal computer, mobile telephone or “MP3” player, for example. The invention provides a number of different methodologies and configurations through which the appropriate control signals can be provided to the headset.

In one embodiment, the media player can be provided with an application that includes an appropriate interface so that the user may select required media delivery preferences and generate an appropriate control signal. The control signal may be an analog signal which includes both the media signal and the control signals. Alternatively, depending upon the connection between the media player and the media delivery device, the control signals may be included in the digital data stream together with the media signal information.

Therefore, in one embodiment a web browser application on a device could utilize a locally installed set of HTML documents/files to allow music to be played which is encoded with selected parameter changes for the processing circuitry provided on the media delivery device 10. This option has the advantage that HTML is agnostic to the operating system and hardware, as is the music media. Furthermore, music can be sent digitally via wireless and USB if required. Also, analogue options exist, as will be described further below.

In another embodiment, Java could be used.

If the media player and the media delivery device 10 are Bluetooth enabled, then in one embodiment the headset may include a Flash memory. This may include a Java® MIDIet or HTML code for example that can be transmitted (using the object Push command of Bluetooth) to the media player. The MIDIet is then loaded into the media player and runs an applet which allows the various media control parameters to be selected by the user, and which generates the appropriate control signals that are transmitted back to the headset to implement the required processing of the media signal.

As an extension of the example described above, the applet which is run on the media player could instigate a search over another network, such as the Internet, for the appropriate code and request that code to be downloaded to the media player.

In another embodiment, the media player and headset may be configured as part of a wireless LAN with the headset effectively being a network device wherein the device comprises the driver.

In yet another embodiment, rather than have an interface present on the media player, the information for generating the control signals is obtained externally. For example, in the example described above in which the media player is instructed to search on a network for required information, the data obtained as a result of that search may comprise an audio file which is streamed to the media player and which when listened to by the user through the headset (or simply played through the headset) contains the information necessary to set up a desired configuration for the user. In other words, the media file that is played through the headset includes the control signals far a particular user setup.

As an alternative or extension to this, the user may manually navigate a website to obtain this information. Furthermore, in accordance with the system, a website may be provided which includes an interface whereby a user may select various options, ie configure a unique customised setup, then when the media file is played, the setup is conveyed by the control signals to the headset 10.

Of course, rather than stream the audio file from the network, the user may simply choose to download a number of audio files which may contain various setup options that the user may have personally configured, and place these on the media player device. In one embodiment, the files that are downloaded may form part of a playlist on the media player with titles which indicate the various options. For example, one file on the playlist may be entitled “Turn active noise cancellation on”. When this file is played, the audio file content comprises one or more control signals which are conveyed from the media player to the headset (or to a processor in the media player) so that the processor implements the required processing to modify the media signal so that an appropriate signal is provided to the headset to deliver the required function to the user. The files that are played in this manner may include audio information for the user to listen to. For example, a tune may be played, or there could be a voice which announce the function that is being implemented. Therefore, quite apart from the title indicating that active noise cancellation is being turned on, the voice-over may actually state “active noise cancellation is now being implemented”. In some instances, the user may simply wish to purchase a headset which has a memory in which audio files may be stored, rather than using a media player in which the files are stored. In other words, the headset itself may include a media player. In this configuration, the user may use an appropriate connection such as a USB interface for example to allow the headset to connect to a PC or a network in order to download appropriate files that contain the required control information. In yet another embodiment, the user may configure the processor and the headset by selecting a desired setup and then downloading the control signals directly without playing any audio file. For example, the configuration of the processor could occur directly using the personal computer as if the processor were an accessory or peripheral device connected to the PC.

Therefore, embodiments of the invention allow media based control using sound or audio files that may be streamed to the device, downloaded, and/or user specified creation thereof—potentially using a local application on a PC or the device itself. By example, instead of using a website to control it, there may exist an application locally which the user runs, which generates the audio signals, and plays them through the PC audio out, to set up the headphone. Thus media based control may be achieved in one or more of the following ways: Dynamically Generated from: External Website, PC Based Application, Media Player Based Application, etc.; Local Media Content (anything previously generated by any of the previous sources); direct connect through Java, Media Player Web Browser, WiFi, etc.

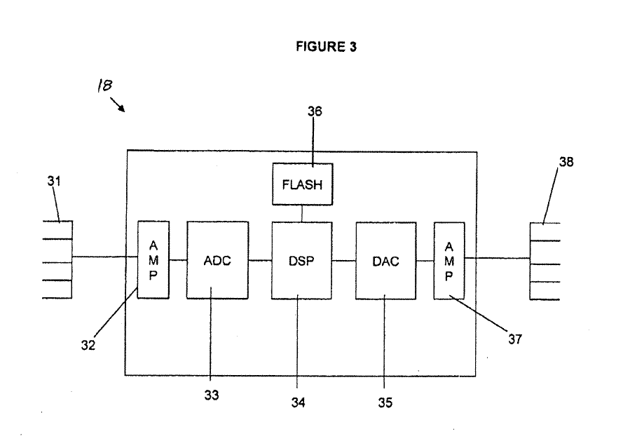

Turning now to FIG. 3, an example of one embodiment of the processing apparatus present in the headset is illustrated. Therefore the processing module comprises input connector 31 connected to amplifier 32. Amplifier 32 is connected to analogue digital converter 33 which is connected to digital signal processor 34. Digital signal processor 34 is connected to digital analogue converter 35 and a flash processor 36. Digital analogue converter 35 is connected to amplifier 37 which is connected to output connector 38. Although not illustrated in FIG. 3, filters may be provided within the processing module to filter the input and output signals.

The media signal is in use amplified by amplifier 32 and passes through the analogue digital converter 33. Digital signal processor 34 and flash processor 36 provide the audio signal processing according to aspects of the invention. For example, digital signal processor 34, in conjunction with flash processor 36, detects and modifies the audio signals received from the media player in accordance with the settings selected by the user and communicated via the control signals. Digital signal processor 34 outputs the modified audio signals to digital analogue converter 35. The signals pass through amplifier 37 and are outputted by output connector 38 to be passed to the transducers which in this instance comprise loudspeakers 12 of the headset 10.

In one embodiment the control signals may be provided as selected tones over an analogue channel using DTMF (Dual Tone Multifrequency) signalling methodology for example. Alternatively, frequency modulation techniques may be used. These methodologies are reasonably well-known. If the channel is an analogue channel, then the frequencies may be above or below those capable of perception by the human ear (eg 25 Hertz), but still capable of transmission over the analogue channel. Alternatively, audio frequencies may be used.

In another embodiment the processor 18 may be provided remote from the transducer. Therefore the processor 18 may be provided as a medallion for example to which earphones are connected (either by a wired or wireless connection). Also, the processor 18 may comprise part of a media player such as a mobile telephone or MP3 player.

The invention provides the user with the ability to fully customise a media entertainment experience, including, for example, active noise cancellation, surround sound, equalisation and voice settings, without burdening the media delivery device such as a headset with a complex set of user controls that ultimately are limited by available space and may be difficult for a user to use. In particular, controls when stored on a headset are cumbersome, aesthetically unappealing and greatly increase costs, while introducing greater incidence of faults. The present invention overcomes these problems.

The system or systems described herein may be implemented on any form of computer or computers and the components may be implemented as dedicated applications or in client-server architectures, including a web-based architecture, and can include functional programs, codes, and code segments. Any of the computers may comprise a processor, a memory for storing program data and executing it, a permanent storage such as a disk drive, a communications port for handling communications with external devices, and user interface devices, including a display, keyboard, mouse, etc. When software modules are involved, these software modules may be stored as program instructions or computer readable codes executable on the processor on a computer-readable media such as read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion. This media can be read by the computer, stored in the memory, and executed by the processor.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the present invention could employ any number of conventional techniques for electronics configuration, signal processing and/or control, data processing and the like.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of “including,” “comprising,” or “having” and variations thereof herein is meant to encompass the items listed thereafter and equivalents hereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those skilled in this art without departing from the spirit and scope of the present invention.

Where, in the foregoing description, reference has been made to specific components or integers of the invention having known equivalents then such equivalents are herein incorporated as if individually set forth.

Although this invention has been described by way of example and with reference to possible embodiments thereof, it is to be understood that modifications or improvements may be made thereto without departing from the scope or spirit of the invention as described herein.

1. Media delivery apparatus comprising:
a processor adapted to receive a media processing control signal corresponding to a media delivery characteristic selected by a user and process a media signal dependent on the media processing control signal to output a modified media signal;
a transducer for receiving the modified media signal and providing the modified media signal for perception by a user.

2. Media delivery apparatus as claimed in claim 1 wherein the media delivery apparatus comprises a headset.

3. Media delivery apparatus as claimed in claim 1 wherein the processor comprises a media player device.

4. Media delivery apparatus as claimed in claim 3 wherein the media processing control signal is obtained from a file stored on the media player device.

5. Media delivery apparatus as claimed in claim 3 wherein the media processing control signal is obtained from a file streamed to the media player device.

6. Media delivery apparatus as claimed in claim 1 wherein the media processing control signal and the media signal are transmitted over the same communication channel.

7. Media delivery apparatus as claimed in claim 1 wherein the media processing control signal programs the processor.

8. Media delivery apparatus as claimed in claim 1 wherein the media processing control signal is received from apparatus remote from the media delivery apparatus.

9. Media delivery apparatus as claimed in claim 1 wherein the media processing control signal alters one or more media processing parameters of the processor.

10. A method for delivering media to a user, the method including the steps of:
receiving an instruction from a user to provide media having a selected characteristic;
providing a media processing control signal corresponding to the selected characteristic to a processor;
using the media processing control signal to program the processor or modify one or more media processing parameters for operation of the processor;
using the processor to process a media signal in accordance with the modified media processing parameter(s) to modify the media signal, and;
providing the modified media signal to the user to thereby provide media having the selected characteristic.
